(19) United States
(12) Patent Application Publication
(10) Pub. No.: US 2007/0255457 A1
(43) Pub. Date: Nov. 1, 2007

(54) Consumer Pollution Impact Profile System and Method

(75) Inventors: Jacob Whitcomb, Worthington, MA (US); Andrew Rossmeissl, Madison, WI (US); Jonathan T. Isham, Cornwall, VT (US); Seamus Abshere, Metuchen, NJ (US)

Correspondence Address: DOWNS RACHLIN MARTIN PLLC, 199 MAIN STREET, P O BOX 190, BURLINGTON, VT, 05402-0190, US

(73) Assignee: BRIGHT PLANET NETWORK, INC., Middlebury, VT (US)

(21) Appl. No.: 11/740,885

(22) Filed: Apr. 26, 2007

Related U.S. Application Data
(60) Provisional application No. 60/796,223, filed on Apr. 28, 2006.

(51) Int. Cl. G05B 21/00

(52) U.S. Cl. 700/273

(57) ABSTRACT

A system and method developing an ongoing relationship with a consumer for assessing the pollution impact attributable to the consumer. The ongoing relationship is provided utilizing a pollution impact profile. In one example a pollution impact profile represents a pollution impact attributable to the consumer. The pollution impact profile may be based on a plurality of categories of pollution impact, each category of pollution impact including an impact arising from one or more pollution-related activities and having an initial value of impact. A pollution impact profile may be associated with one or more pollution offsetting services. A pollution impact profile may be configured to allow a consumer to have an ongoing relationship with information related to an associated pollution impact attributed to the consumer.

### RELATED APPLICATION DATA

This application claims the benefit of priority of U.S. Provisional Patent Application Ser. No. 60/796,223, filed Apr. 28, 2006, and titled “Pollution Offset Credit Account System and Method,” which is incorporated by reference herein in its entirety.

### FIELD OF THE INVENTION

The present invention generally relates to the field of pollution impact monitoring. In particular, the present invention is directed to a consumer pollution impact profile system and method.

### BACKGROUND

Many Americans now consider global warming to be an urgent problem that requires action. Consumer desire to contribute to this problem's solution represents a considerable untapped market. Some environmentalist consumers have been bringing their values to market for decades—at an additional expense of both time and money. The passive majority, however, have never been given opportunities to express their environmentalist values without sustaining these costs.

Many activities of consumers, and the systems and services that support consumers, produce pollution of one or more types. Examples of pollution include, but are not limited to, carbon emissions (e.g., carbon dioxide emissions and other pollutants, such as greenhouse gasses, that are measured in carbon dioxide emission equivalents), NOx emissions, noise, light, consumer waste, consumer waste pollution, and any combinations thereof. Many consumers have become aware of the negative impacts of the various types of pollution and seek ways to minimize the impact of pollution on the environment.

One way to measure the impact that pollution may have is via a pollution footprint (e.g., a carbon footprint). Recently, carbon emission calculators that assist consumers in calculating their carbon emission footprint have appeared on the Internet. Unfortunately, these calculators are typically inaccurate attempts at deriving an individual consumer's footprint and/or are often consuming and lengthy to complete.

### SUMMARY OF THE DISCLOSURE

In one embodiment, a machine-implemented method of developing an ongoing relationship with a consumer for assessing the pollution impact attributable to the consumer is provided. The method includes providing a first interactive session for use by the consumer; providing a pollution impact profile representing a pollution impact attributable to the consumer wherein the pollution impact profile is based on a plurality of categories of pollution impact, each category of pollution impact including an impact arising from one or more pollution-related activities and having an initial value of impact; allowing the consumer to provide a first data representing the consumer's actual pollution-related activities in at least one of the plurality of categories of pollution impact; replacing at least a portion of the corresponding initial value of impact with the first data; associating the pollution impact profile and the first data with the consumer such that the consumer may access the pollution impact profile during a second interactive session initiated after the termination of the first interactive session; providing a first indicator of a pollution footprint based on the provided data and/or one or more of the initial values of impact; allowing the consumer to associate one or more pollution offsetting services with the pollution impact profile for providing data related to pollution offset by the consumer; and providing a second indicator based on an amount of pollution offset by the consumer.

In another embodiment, a system for developing an ongoing relationship with a consumer for assessing the pollution impact attributable to the consumer is provided. The system includes a means for providing a first interactive session for use by the consumer; a means for providing a pollution impact profile representing a pollution impact attributable to the consumer wherein the pollution impact profile is based on a plurality of categories of pollution impact, each category of pollution impact including an impact arising from one or more pollution-related activities and having an initial value of impact; a means for allowing the consumer to provide a first data representing the consumer's actual pollution-related activities in at least one of the plurality of categories of pollution impact; a means for replacing at least a portion of the corresponding initial value of impact with the first data; a means for associating the pollution impact profile and the first data with the consumer such that the consumer may access the pollution impact profile during a second interactive session initiated after the termination of the first interactive session; a means for providing a first indicator of a pollution footprint based on the provided data and/or one or more of the initial values of impact; a means for allowing the consumer to associate one or more pollution offsetting services with the pollution impact profile for providing data related to pollution offset by the consumer; and a means for providing a second indicator of the progress of the consumer toward offsetting the pollution footprint.

In yet another embodiment, a machine-readable medium containing computer executable instructions implementing a method of developing an ongoing relationship with a consumer for assessing the pollution impact attributable to the consumer is provided. The instructions include a set of instructions for providing a first interactive session for use by the consumer; a set of instructions for providing a pollution impact profile representing a pollution impact attributable to the consumer wherein the pollution impact profile is based on a plurality of categories of pollution impact, each category of pollution impact including an impact arising from one or more pollution-related activities and having an initial value of impact; a set of instructions for allowing the consumer to provide a first data representing the consumer's actual pollution-related activities in at least one of the plurality of categories of pollution impact; a set of instructions for replacing at least a portion of the corresponding initial value of impact with the first data; a set of instructions for associating the pollution impact profile and the first data with the consumer such that the consumer may access the pollution impact profile during a second interactive session initiated after the termination of the first interactive session; a set of instructions for providing a first indicator of a pollution footprint based on the provided data and/or one or more of the initial values of impact; a set of instructions for allowing the consumer to associate one or more pollution offsetting services with the pollution impact profile for providing data related to pollution offset by the consumer; and a set of instructions for providing a second indicator of the progress of the consumer toward offsetting the pollution footprint.

In still another embodiment, a machine-implemented method of developing an ongoing relationship with a consumer for assessing the pollution impact attributable to the consumer is provided. The method includes providing a first interactive session for use by the consumer; providing a pollution impact profile representing a pollution impact attributable to the consumer wherein the pollution impact profile is based on a plurality of categories of pollution impact including one or more allocated categories each representing a specific type of impact arising from a related one or more activities and an unallocated category representing a portion of the pollution impact attributable to the consumer that is not allocated to a specific type of impact, wherein each of the plurality of categories has an initial value of impact; allowing the consumer to provide a first data representing the consumer's actual pollution-related activities in at least one of the plurality of categories of impact for replacing at least a portion of the corresponding initial value of impact; associating the pollution impact profile and the first data with the consumer such that the consumer may access the pollution impact profile during a second interactive session initiated after the termination of the first interactive session; providing a first indicator of a pollution footprint based on the provided data and/or one or more of the initial values of impact; and updating the pollution impact profile by allocating at least a portion of the unallocated category to a new or existing allocated category of pollution impact; and providing a second indicator of the pollution footprint utilizing a value based on the updated pollution impact profile.

In still yet another embodiment, a pollution impact system for developing an ongoing relationship with a consumer that relates to a pollution impact attributable to the consumer is provided. The system includes a database accessible via a network; and a pollution impact profile in the database, the pollution impact profile including: a plurality of allocated categories of pollution impact, each of the plurality of categories based on one or more data elements associated with a corresponding one or more activities related to a pollution impact, each of the plurality of allocated categories representing a first portion of the pollution impact attributable to the consumer and having an initial value of impact in the database, wherein each of the plurality of categories is configured to be accessed and modified by the consumer with one or more actual pollution impact data values that relate to at least one of the one or more data elements; and an unallocated category of pollution impact representing a second portion of the pollution impact attributable to the consumer that is not allocated to one of the plurality of allocated categories, wherein the second portion is configured to be modified to be allocated to a new allocated category upon acquisition of knew knowledge related to one or more activities that contribute to the pollution impact attributable to the consumer.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one embodiment of a system having a pollution impact profiler for allowing the development of an ongoing relationship with a consumer for assessing a pollution impact attributable to a consumer;

FIG. 2 illustrates one embodiment of a pollution impact profile;

FIG. 3 illustrates one embodiment of an interactive session;

FIG. 4 illustrates one embodiment of a pollution impact profile in an initial state having initial pollution impact data for each allocated category and a modified state having actual pollution impact data of a consumer associated with one or more categories;

FIG. 5 illustrates one embodiment of a pollution impact profile in an initial state and a modified state having a portion of an unallocated category allocated to a new allocated category;

FIG. 6 illustrates one embodiment of a method of developing an ongoing relationship with a consumer;

FIG. 7 illustrates one embodiment of associating one or more pollution offsetting services with a pollution impact profile;

FIG. 8 illustrates one embodiment of a graphical depiction of an exemplary pollution impact profile; and

FIG. 9 illustrates one embodiment of a computing environment for implementing a system and/or method of developing an ongoing relationship with a consumer according to the disclosure herein.

### DETAILED DESCRIPTION

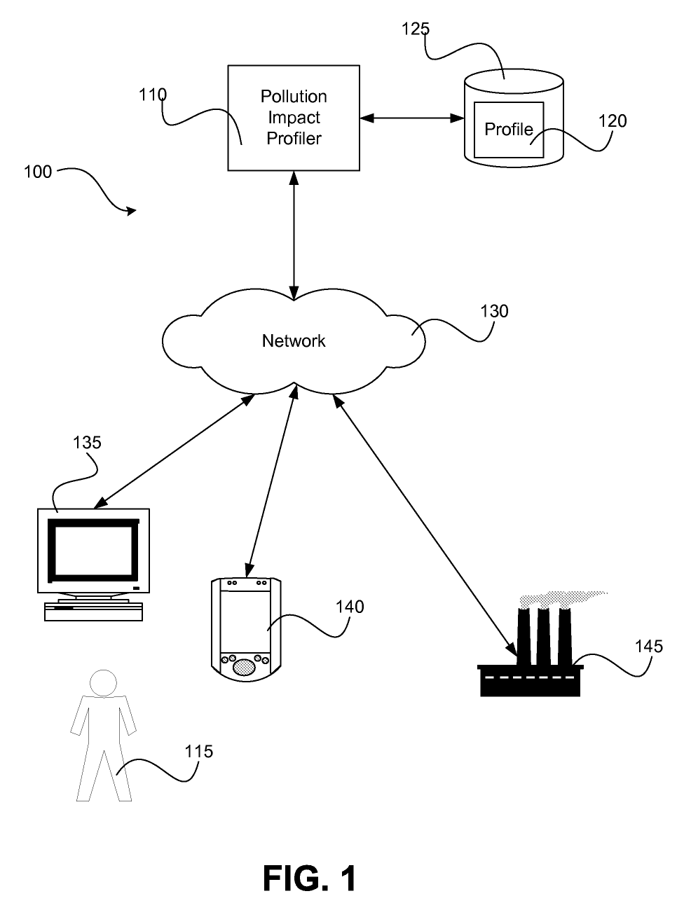

FIG. 1 illustrates one embodiment of a system 100 having a pollution impact profiler 110. Pollution impact profiler 110 may be configured to allow the development and/or maintenance of an ongoing relationship with a consumer 115 for assessing (e.g., tracking, developing, measuring, modifying and/or offsetting) a pollution impact attributable to consumer 115. As discussed above many types of pollution may have an impact on the environment. Examples discussed herein may refer to carbon emission pollution. However, it is contemplated that carbon emission pollution may be replaced and/or supplemented in these examples with any one or more types of pollution. Where “a pollution impact” is discussed herein, it is contemplated that such an impact may include any one or more impacts of any one or more types of pollution. In one exemplary aspect, pollution impact profiler 110 can be configured to allow consumer 115 to access a pollution impact profile 120. In one example, pollution impact profile 120 for consumer 115 is stored in a database 125. Profiler 110 may provide controlled access to database 125 and profile 120 to consumer 115. For example, a username and/or passcode unique to an individual consumer 115 may be utilized to control access. A default pollution impact profile and specific instantiations of a pollution impact profile associated with a consumer may include information for assessing pollution impact attributable to a consumer, including, but not limited to, a pollution footprint, a offset to a pollution footprint, data related to (and/or required to determine) either, and any combinations thereof. A default pollution impact profile may be based on one or more estimated values of pollution impact. A pollution impact profile associated with a specific consumer may then be modified with specific actual pollution impact data.

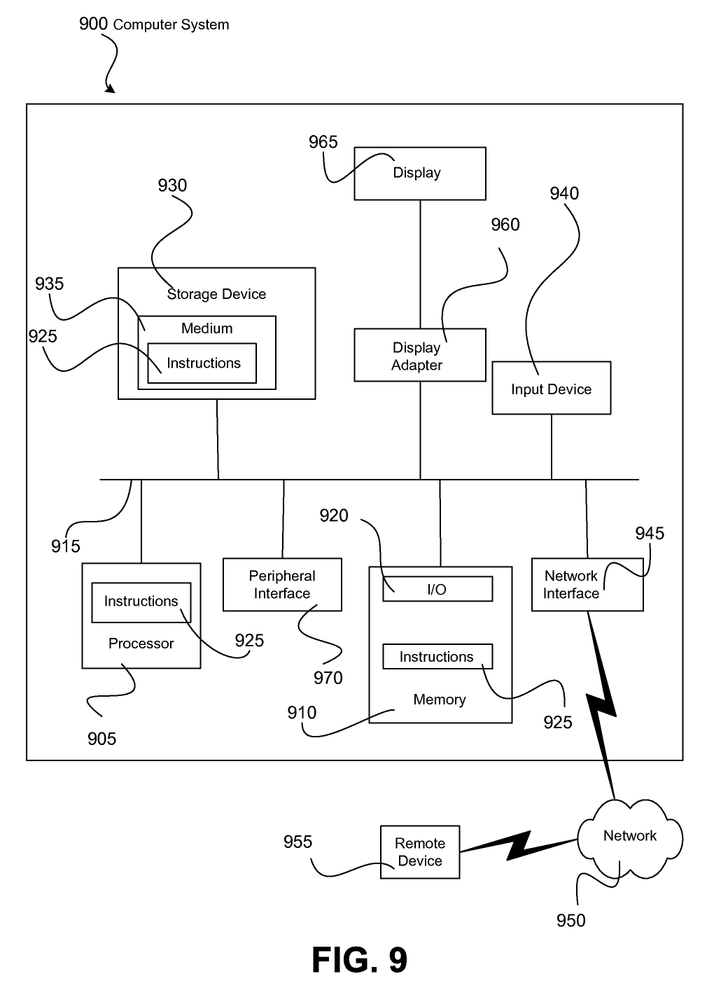

Typically, access to profile 120 may occur over a network 130 using a device capable of communication over a network and configured to interact with profile 120. Example networks and devices for accessing a profile are discussed further below with respect to FIG. 9. In one example, a computer 135 is connected to network 130 for providing access to profile 120 by consumer 115. In another example, a mobile device 140 (e.g., a Personal Data Assistant, mobile telephone) is connected to network 130 for providing access to profile 120 by consumer 115. As will be discussed further below, other devices and/or systems may be in communication with pollution impact profiler 110 via a network (e.g., network 130) for inputting and/or outputting information with respect to profile 120. For example, system 100 includes a connection from network 130 to a utility provider 145 of consumer 115. Such a connection may allow utility provider 145 to input data related to pollution impact of utility provision to consumer 115. In one aspect, such information and other data provided to pollution impact profile 120 may be utilized to determine a pollution impact attributable to a consumer that is more specific to that consumer.

A pollution impact profile, such as profile 120, may be utilized to allow the consumer to customize and modify their pollution footprint over time. A pollution footprint profile may also allow a consumer to track their progress (e.g., via pollution offsets) in diminishing their pollution footprint. In one example, a consumer's pollution footprint may include an amount of any one or more types of pollution attributable to a consumer over a period of time (e.g., a month, a year, indefinitely, etc.). One such example includes a carbon footprint including an amount of carbon emission pollution attributable to a consumer over a period of a year.

An amount of pollution attributable to a consumer may be calculated by a variety of ways. In one example, an amount of pollution attributable to a consumer may be determined by determining a total carbon emission pollution generated by all activities within a geographic region having a population of a number of individuals that includes the consumer. The total carbon emission pollution is then divided by the number of individuals in the population to obtain the amount of pollution attributable to the individual consumer. The total pollution of a geographic region includes all of the particular type of pollution (e.g., carbon emission pollution) produced by shared activities of the population and the sum of that type of pollution produced by the individual activities of the members of the population. Examples of shared activities include, but are not limited to, municipal activities, military activities, naturally occurring pollution, and power production. Typically, an individual consumer does not have direct control over this shared amount of pollution contributed to their footprint. A consumer may have indirect control over this impact (e.g., via efforts to change municipal/government behavior, choice of location of residence, etc.). Examples of individual activities include, but are not limited to, home heating, home cooling, automobile operation, rail travel, air travel, bus travel, and individual electrical usage. As an example, an amount of carbon emission pollution attributable to a particular consumer in the United States for an example year may be about 21 short tons (“tons”), which may be determined by dividing the total carbon emission pollution of the United States by the total population for that example year. To determine a footprint in this fashion, no specific information about an individual consumer's pollution related activities is required. However, such a footprint would not be specific to the individual consumer.

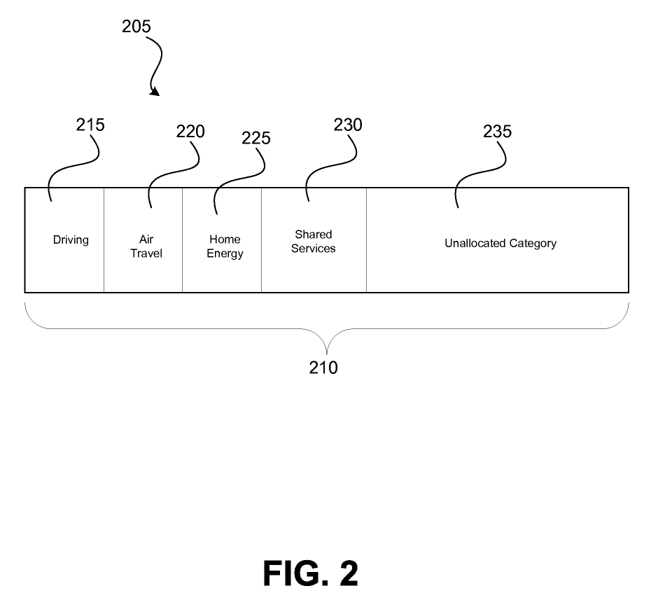

In an alternative embodiment, a more accurate assessment of an individual consumer's pollution footprint may be obtained by utilizing a pollution impact profile. A pollution impact profile may includes a more personalized accounting of the consumer's actual activities and the corresponding pollution impact of those activities. In one example, a pollution impact profile may be configured to allow a consumer to return to modify and/or add information to the profile. FIG. 2 illustrates a representation of an example of such a pollution impact profile 205. Profile 205 includes an amount 210 of pollution impact attributable to an individual consumer. The pollution impact represented as part of profile 205 may be any one or more types of pollution. For exemplary purposes, profile 205 is shown with respect to carbon emission pollution. Profile 205 includes five categories of pollution impact, including a driving category 215, an air travel category 220, a home energy category 225, a shared services category 230, and an unallocated category 235. Although profile 205 is shown with five categories, it is contemplated that a pollution impact profile may have any number of categories of pollution impact. Each category may represent an impact arising from one or more pollution-related activities. For example in profile 205, driving category 215 may include an amount of carbon emission arising from activities related to operating an automobile. Air travel category 220 may include an amount of carbon emission arising from activities related to travel by air. Home energy category 225 may include an amount of carbon emission arising from providing energy to a consumer's home (e.g., heating and/or electricity usage). In alternative examples, each of categories 215, 220, 225 may be further divided into additional categories (e.g., business air travel and personal air travel) and/or lumped together into broader categories (e.g., placing air and driving into one broader travel category). Shared services category 230 may include an amount of carbon emission arising from activities that are shared by more than one consumer (e.g., lighting streetlights, maintaining municipal function, etc.). Unallocated category 235 may account for any portion of the total amount 210 of attributable impact that is not allocated to a specific category. Unallocated categories are discussed further below.

Each category may be based on one or more data elements related to the corresponding activity. For example, a driving category may be based on data elements including, but not limited to, the type of automobile driven, gas mileage of a particular model automobile, actual or estimated miles driven over a period of time, driving habits (e.g., aggressive stopping and starting), location of driving (e.g., amount of time driving in the city, amount of time driving on a highway), and any combinations thereof. Additionally, a single data element may have an impact on more than one category. For example, a data element of a zip code may be utilized to determine an amount of carbon emission produced for home energy by relating known sources of energy production for the geographic region having the zip code to the calculation of the amount of carbon emission for a home energy category (e.g., a region has a primary source of electricity that is nuclear powered will have less carbon emissions related to electricity production than a region that relies heavily on coal fired energy production). A zip code data element may also be utilized to determine an amount of carbon emission related to air travel as certain regions require lengthier flights on average to reach major destinations. It should be noted that data elements may represent one or more activities taken by a consumer or other party that mitigate pollution impact (e.g., use of exhaust filtration, turning off unused energy consuming devices, utilizing energy saving appliances, and other behaviors that reduce pollution and/or usage of energy). In one aspect, exemplary algorithms and/or other processes for determining a pollution impact based on data associated with one or more data elements will be understood by those of ordinary skill from the disclosure herein.

In one exemplary implementation of a pollution impact profile, such as profile 205, one or more of the categories, and or one or more of the data elements that contribute to a category may be assigned initial values of pollution impact using known average values for pollution impact. For example, total impact 210 may initially be calculated by determining the total carbon emissions for the United States for a particular time period and dividing that value by the total population. This initial value of the impact 210 may be used to represent the average consumer's pollution footprint (e.g., an initial pollution footprint that does not take into consideration actual knowledge of a specific consumer's pollution-related activities). Using known information, estimated average values for carbon emission related to any one or more of driving category 215, air travel category 220, home energy category 225, and shared services category 230 can be initially assigned to a category and/or to one or more of the data elements that make up a category. For example, the average carbon emissions for an individual related to driving in the United States for a year may be known and assigned to driving category 215. In another example, the average number of airplane flights for an individual consumer and the average distance of an airplane flight may be known and assigned to corresponding data elements of air travel category 220. In one example, from these initial values of the data elements, an average initial value for the carbon emission impact for air travel category 220 may be calculated. Initial values for each specific category of a pollution impact profile may be determined (e.g., from initial values of data elements). Any pollution impact of the total impact (e.g., impact 210) attributable to the average consumer that remains after taking into consideration initial values of pollution impact assigned to each specific category may be assigned to an unallocated category (e.g., unallocated category 235). In one aspect, this unallocated category may provide flexibility in modifying and/or making more accurate a pollution impact profile. In one example of an initial profile, a total carbon emission attributable to an average consumer for a year is about 21 tons and total value 210 is assigned an initial value of 21 tons. In this example, using publicly known information about driving, air travel, home energy consumption, and certain shared services, initial values of about 4 tons, about 2 tons, about 5 tons, and about 5 tons, respectively are assigned to specific categories 215, 220, 225, and 230. The remaining 5 tons of carbon emission of the total 21 tons is assigned to unallocated category 235.

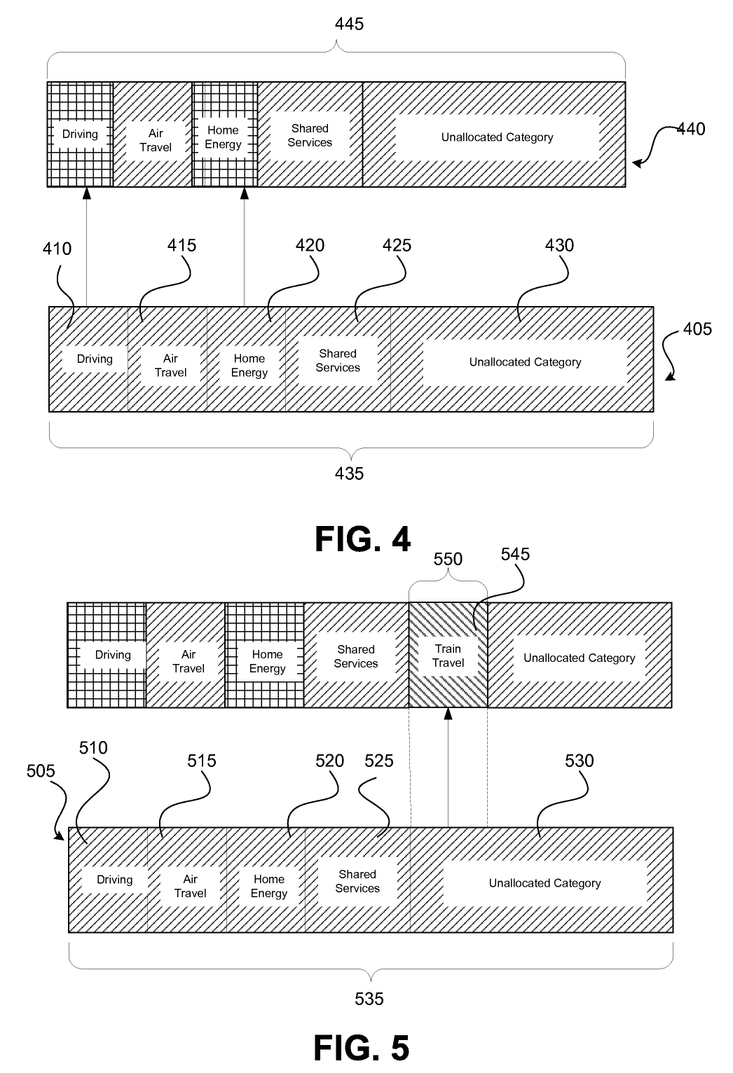

In one exemplary embodiment, a pollution impact profile (e.g., profile 205) initially populated with estimated values, as described above, may be used as a template to create one or more instantiations of specific profiles each to associate with a specific consumer. In one example, instantiations of a default profile may be modified with actual data related to a consumer's pollution related activities as described below with respect to an example in relation to FIG. 4. In another example, a template profile (e.g., an initial profile) and one or more instantiations created therefrom modified (e.g., adding a category, adding a data element, changing a category, changing a data element or an initial value associated therewith, etc.), for example as described further below with respect to an example in relation to FIG. 5.

In one aspect, pollution impact profile 205 may allow a consumer to be assigned an initial pollution footprint. In one example, a consumer may be content with this average pollution footprint value. In another example, a consumer may wish to modify their specific pollution impact profile 205 to more accurately represent their particular pollution footprint. Pollution impact profile 205 may be configured to allow a consumer to modify one or more data elements associated with one or more categories in order to replace and/or improve upon the initial values of pollution impact. In one example, the consumer can provide actual data values for less than all of the data elements of profile 205 at any given time. Profile 205 is configured to allow an ongoing relationship with the consumer such that the consumer need not provide actual data values for all aspects of profile 205 in order to obtain a pollution footprint value.

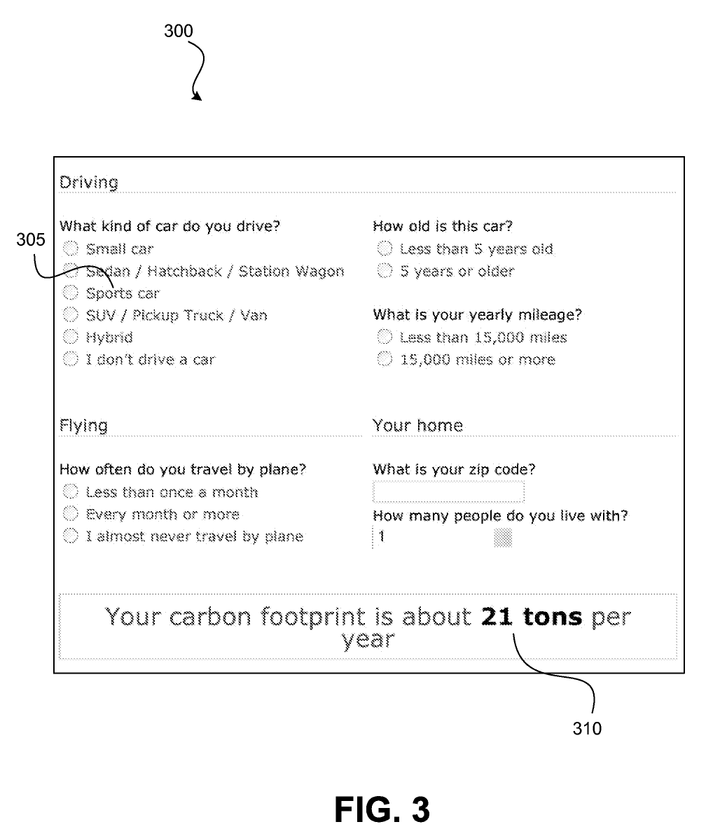

An ongoing relationship between a consumer and a corresponding pollution impact profile (e.g., profile 205) may include one or more interactive sessions. FIG. 3 illustrates an example graphical representation of one embodiment of an interactive session 300. Interactive session 300 may be provided to a consumer in a variety of ways. Examples of ways to provide interactive session 300 include, but are not limited to, generation of one or more displayable images for display on a display device. Example display devices and associated machines for executing displayable images are described further below with respect to FIG. 9. Interactive session 300 illustrates a number of prompts 305 for data input related to data elements of one or more specific categories of pollution impact. Interactive session 300 also includes a carbon footprint indicator 310. In the example shown in FIG. 3, a consumer has not yet responded to prompts 305 and carbon footprint indicator 310 illustrates an initial carbon footprint based on average values of 21 tons. In one example, a consumer may provide actual data to a profile by responding to one or more prompts 305. Carbon footprint indicator 310 is shown as a numerical depiction of a carbon footprint. A carbon footprint indicator may be provided to a consumer in a variety of ways. Examples of ways to provide a carbon footprint indicator include, but are not limited to, text, bar graphic, pie chart, bubble chart, area chart, line chart, and any combinations thereof. Carbon footprint indicator 310 is shown as representing the total carbon footprint. In another example, a carbon footprint indicator may depict a value for one or more specific categories of pollution impact as a replacement or in addition to a total value of a pollution footprint. An interactive session may also include one or more displayable images or other tools for example to allow registering a consumer, associating a profile with a consumer, associating a service with a profile (e.g., as discussed further below with respect to pollution offsets), and other tasks described herein.

A consumer may utilize an interactive session (e.g., interactive session 300) to input specific actual data representing the consumer's actual pollution impact. A pollution impact profile associated with the consumer may then utilize the data to replace and/or supplement one or more initial data values of data elements associated with one or more categories of the profile. A more specific pollution footprint value may then be generated. For example, a consumer may utilize prompts 305 to provide actual data related to type of car, age of the car, and yearly mileage. The corresponding pollution impact profile may have had initial values for these data elements or may have had no values for these data elements (e.g., may have had an initial value of carbon emission estimated from averages for the associated driving category, but no specific initial data value for individual data elements that may contribute to carbon emission in the driving category). The actual data provided by the consumer may be used to improve the carbon footprint associated with the profile. For example, the consumer may drive a new, fuel efficient hybrid car less than 15,000 miles per year. The associated profile may utilize related data input by the consumer via interactive session 300 and known information about the impact of that data on carbon emission to determine a lower carbon footprint than the provided initial value. Indicator 310 could then be updated. In another example, a consumer may drive a less efficient older SUV more than 15,000 miles per year. It may be expected that this data would correspond to a higher pollution impact than the average initial value. Indicator 310 could then be updated.

Data provided by a consumer and/or values of impact of pollution determined therefrom (e.g., at the category level, at the profile level) may be retained by the profile (e.g., stored in or in association with the profile). In one example, a data element provided by a consumer replaces an initial or previous data value of a corresponding data element of one or more specific categories of pollution impact stored in a database (e.g., database 125 of FIG. 1).

Data may be provided to a profile by a consumer and/or a third-party in a variety of ways. Example ways for providing data include, but are not limited to, a web page, an SMS, a text message, a web services dialogue using an application programming interface (API), a formatted email message, an instant message (e.g., AOL Instant Messenger), an electronic chat message (e.g., an Internet Relay Chat message), a widget message (e.g., a Google Desktop widget), wireless data communication, a data communication from a device installed in an automobile or other vehicle that communicates data (e.g., fuel consumption, emission data, mileage, etc.) related to vehicle operation, a data communication from a device installed in a home that communicates data (e.g., electricity usage, heating fuel consumption) related to pollution-generating home use, a data communication from a travel operator (e.g., reporting air, bus, train travel data), a data communication from a touch-tone telephone, a data communication from a utility provider, and any combinations thereof. In one example, an interactive session may include only the provision of data to a pollution impact profile. In another example, an interactive session may include providing information to a consumer and/or third-party (e.g., prompts for data, an indicator of pollution impact) and the provision of data to the pollution impact profile.

FIG. 4 illustrates a first graphical depiction 405 of one embodiment of a pollution impact profile having a driving category 410, an air travel category 415, a home energy category 420, a shared services category 425, and an unallocated category 430. The diagonal hatching represents initial values of pollution impact and/or one or more data elements associated with each category. The profile has a total initial pollution impact 435 attributable for example to an average consumer. A consumer may provide data that modifies and/or replaces one or more data elements associated with driving category 410 and home energy category 420, as represented by the two arrows. A second graphical depiction 440 of the same profile illustrates the profile after the data is provided by the consumer. The cross hatching in the driving category 410 and the home energy category 420 illustrate the added and/or modified value of pollution impact associated with each of the categories and/or data elements. The second graphical depiction also illustrates an updated total pollution impact 445 attributable to the associated specific consumer. Although, in this example, air travel category 415 and shared services category 425 are not updated from the initial values by the data provided by the consumer, updated total pollution impact 445 provides a more accurate assessment of the pollution impact attributable to the specific consumer than the initial estimated impact 435.

A consumer and/or the provider of a pollution impact profiler (e.g., profiler 110 of FIG. 1) may initiate a later interactive session after the termination of an initial or previous interactive session (e.g., interactive session 300 of FIG. 3) for providing access to the consumer's associated pollution impact profile. The later interactive session may be for a variety of purposes related to a consumer's pollution impact profile. Example purposes include, but are not limited to, providing a review of profile data elements (e.g., data values provided by a consumer and/or default initial values of a profile), providing a review of a current pollution footprint indicator, allowing a consumer to provide additional and/or updated data, publishing a current pollution footprint indicator, providing a review of current pollution reduction (see further description below of pollution offsets and a pollution impact profile), and any combinations thereof.

In an alternative embodiment, as a consumer provides data via an interactive session, such as interactive session 300 (e.g., at each entry of an individual data element, at completion of entry of data elements related to a category), the provided indicator of pollution footprint (e.g., indicator 310) may iteratively update based on the provided data. For example, as a consumer provides data related to their zip code, the associated pollution impact profile utilizes the data to replace one or more data elements associated with a home energy category and an air travel category to update the total value of carbon emission impact and the corresponding indicator of carbon footprint may change (e.g., from 21 tons to 19 tons).

A pollution impact profile may be further improved by modifying one or more categories, changing the category structure of a profile (e.g., adding, modifying, removing one or more categories), and/or changing the basic data element structure of one or more categories (e.g., adding, modifying, removing one or more data elements of a category). Such changes may occur at any time including, but not limited to, before a consumer is associated with a profile, after a consumer is associated with a profile, before a consumer provides actual data to a profile, after a consumer provides actual data to a profile, while a consumer is providing actual data to the profile, and any combinations thereof. In one example, one or more additional data elements may be added to a category to more precisely describe a pollution impact attributable to one or more activities associated with the category. In one such example, an additional data element (e.g., time driving on highway, time driving in city driving) is added to a driving category of a profile to further clarify a pollution impact based on driving. In another example, one or more additional categories are added to a pollution impact profile. In one such example, as more information becomes known about a particular type of impact (e.g., train travel), a portion of an unallocated category may be specifically allocated to a train travel category. In a further example, information necessary to further improve a profile may be determined by answers to prompts provided to a plurality of consumers having profiles. Data provided in response to the prompts may provide information that may be used to generate estimates of new categories of pollution impact and/or modify existing categories of pollution impact.

FIG. 5 illustrates a graphical depiction 505 of one embodiment of a pollution impact profile having a driving category 510, an air travel category 515, a home energy category 520, a shared services category 525, and an unallocated category 530. The diagonal hatching represents initial values of pollution impact and/or data elements associated with each category. The cross hatching in the driving category 510 and the home energy category 520 illustrate the added and/or modified value of pollution impact associated with each of these categories and/or data elements based on data provided by an associated consumer. The profile has a total updated pollution impact 535 attributable to the consumer. Unallocated category 530 accounts for the portion of the total initial pollution impact (see for example, total initial pollution impact 435 of FIG. 4) that is not allocated to a specified category (e.g., driving category 510, air travel category 515, home energy category 520, and shared services category 525). A second graphical depiction 540 of the same profile illustrates the profile after the addition of a new specific category, a train travel category 545 representing an amount of pollution impact 550 of the total amount 535 that is attributable to train travel. Here, the opposite direction diagonal hatching indicates a new initial estimated value (e.g., determined from known average information about an average consumer's train travel) of pollution impact for train travel category 545 and a new updated value of remaining amount of pollution impact for unallocated category 530. Although this example illustrates the addition of train travel category 545 to an already modified profile (e.g., after a consumer has provided actual data), such an addition may be made to a pollution impact profile prior to any actual data being provided for a specific instantiation of a profile by a consumer or third-party.

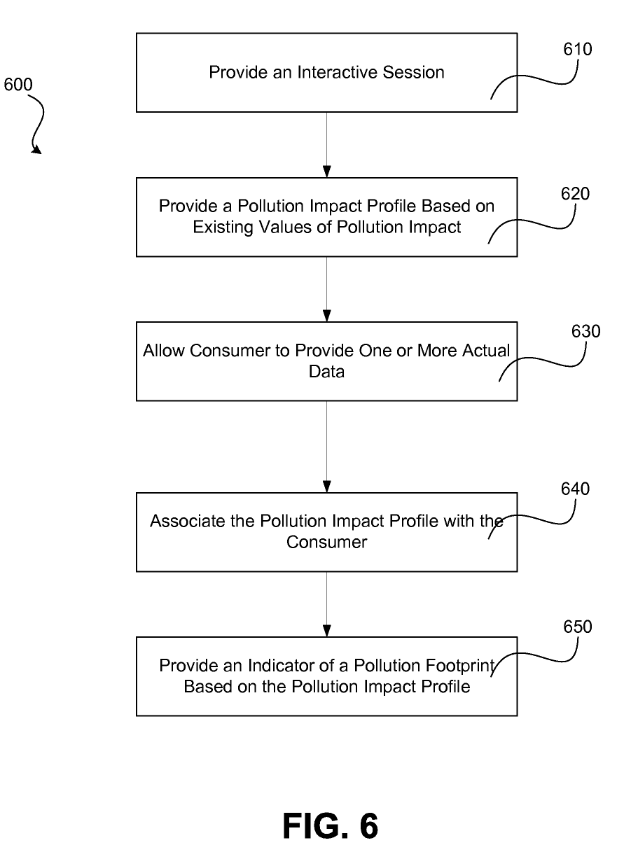

FIG. 6 illustrates one embodiment of a method 600 for developing an ongoing relationship with a consumer for offsetting a pollution impact attributable to the consumer. At step 610, a first interactive session is provided for use by the consumer. As discussed above, the consumer and/or a third-party acting on their behalf may utilize an interactive session to access a pollution impact profile (e.g., pollution impact profile 205 of FIG. 2).

At step 620, a pollution impact profile is provided. If the interactive session is a first session for a given consumer, the consumer (or the third-party acting on their behalf) may be provided with a prompt (e.g., a displayable image) to register (e.g., establish a username and/or password). In such a case, the pollution impact profile may have one or more categories (or associated data elements) of pollution impact that have an initial value that is estimated, as discussed above (e.g., from an initial template profile). In another example, where the interactive session is a follow-up session, the pollution impact profile may include actual data provided by the consumer or an associated third-party. In yet another example, a profile may be created for a consumer by a service provider (e.g., an offsetting service provider, as discussed further below).

At step 630, a consumer is allowed to provide one or more actual data representing the consumer's actual pollution-related activity in at least one of the categories of the pollution impact profile. The one or more actual data may replace at least a portion of the initial value of the corresponding category. As discussed above, the replacement of a portion of the initial value of impact (e.g., an estimated initial value or a value determined in a previous session from actual data provided) may occur via a replacement or update of the prior value. In one example, a consumer may utilize a network (e.g., network 130 of FIG. 1) to provide data to a profile.

At step 640, the pollution impact profile is associated with the consumer. In one example, this association may occur as part of the registration process discussed above. In an alternative example, an association may have been made in a prior interactive session with a consumer. In another example of association, a data element identifying the consumer may be saved in or associated with the profile (e.g., in a database, such as database 125 of FIG. 1). In one aspect, this association and the saving of data in association with the profile, in one example, allows a consumer to access their associated profile after the termination of the current interactive session. In another example, an ability to access a pollution impact profile on an ongoing basis may allow a user to gain an initial understanding of their pollution footprint during a first session in which they may or may not provide actual pollution-impact data and to return during a second session to add and/or modify actual pollution-impact data. In yet another example, an ability to access a pollution impact profile on an ongoing basis may minimize the burden on a consumer in providing detailed information related to their actual pollution impact. The flexibility of a pollution impact profile may encourage, in some instances, greater utilization of the pollution impact profile to understand a consumer's pollution footprint.

At step 650, an indicator of a pollution footprint based on the pollution impact profile is provided. In one example, a pollution footprint may represent an initial estimated value (e.g., a value based on initial values of the pollution impact profile) of an amount of a pollution impact attributable to the consumer. In another example, a pollution footprint may represent a more refined amount of pollution impact attributable to the consumer by including in the determination of the pollution footprint one or more actual data of pollution-related activity that have been provided.

As discussed above, providing of an indicator of a pollution footprint may occur in a variety of ways. Example ways of providing an indicator of a pollution footprint include, but are not limited to, a web page, an email, an electronic signature, a mobile device display, a financial account statement, a personal away message (e.g., email, voice mail, chat, instant message away messages), a publicly accessible advertisement, structured data syndication (e.g., XML-based syndication), SMS, postal mailing, instant messaging, audio feed, audio phone call and/or message, publication to an automobile dashboard, other electronic and non-electronic publication media, and any combinations thereof. Other indicators may also be provided in a same and/or different fashion as the indicator of a pollution footprint. For example, an indicator of an amount of a pollution impact (e.g. an amount of a pollution footprint) that is offset by a consumer may also be provided. Such an example is discussed further below with respect to offsetting pollution impact. Publication and/or other provision of an indicator may occur at any interval. Example publication intervals include, but are not limited to, daily, weekly, monthly, yearly, and any combinations thereof.

In another embodiment, a consumer may offset a portion or all of their pollution footprint by one or more activities. In one example, one or more pollution offsetting services may be associated with a consumer's corresponding pollution impact profile. A pollution offsetting service may provide an opportunity to a consumer to offset the impact of the pollution attributed to that consumer. A variety of offsetting activities are available. Example pollution offsetting activities include, but are not limited to, purchasing and retiring pollution offsets (e.g., carbon credits), planting trees, investing in environmentally friendly energy projects, investing in new technologies to reduce atmospheric carbon dioxide and/or other greenhouse gas concentrations, investing in water cleanup projects, investing in cleaner waste-management technologies and practices, and any combinations thereof. A pollution offset, such as a carbon emission offset, may be purchased in a variety of ways. Example ways to purchase a pollution offset include, but are not limited to, purchase on a commodity exchange, purchase from an environmental organization (e.g., NativeEnergy of Charlotte, Vt.), and CarbonFund of Silversprings, Md.). Examples of an environmentally clean energy project include, but are not limited to, a wind farm energy project, a solar energy project, a small hydro energy project, a geothermal energy project, a biomass energy project, a methane energy project, a carbon sequestration project (e.g., reforestation), a water cleanup project, a noise reduction project, a clean waste-water management project, and any combinations thereof.

In one example, a pollution offset may represent a measured pollution reduction effected by modifying an existing system or constructing a new system. In one example, an emission offset may be traded as a commodity. In another example, an emission offset may be a certified emission offset. In yet another example, a certified emission offset includes an offset that is certified to be generated by new construction of an environmentally clean energy production facility (e.g., a renewable energy project). In another embodiment, a purchased pollution offset may be retired. In one example, a pollution offset (e.g., a Green Tag, discussed further below) may be permanently retired by an operator of a system and/or method of the present disclosure. In another example, a pollution offset (e.g., a carbon offset) may be permanently retired via a pollution offset retirement organization, such as Clean Air Cool Planet of Portsmouth, N.H. A pollution offset retirement organization ensures that the green tags are not resold on the market at a later date.

One example of an pollution offset is a Green Tag emission offset. A Green Tag is a tradable credit that represents the reduction in CO₂ and other pollutants that occur when renewable energy substitutes coal and fossil fuel burning energy on an energy grid. A renewable energy project may have two flows of revenue associated with it: the value of the energy sold to the grid, and the value of the renewable energy's displacement of an equal amount of polluting energy from the grid. The latter, the environmental benefits, may be packaged and sold as green tags, which represent ownership of the associated project's environmental attributes, also known as greenhouse gas emissions reductions. Green tag revenues accompany revenues from the area electric grid to fund the construction and use of wind farms and other renewable energy projects. Since renewable energy production costs a little more than energy from old fossil fuel burning plants, green tags have been created to subsidize these energy projects and are traded on a voluntary carbon exchange. Green tags may be purchased at the renewable energy developer's discounted present value for the construction and lifetime operation of the project and/or for the current year of the operation of the project. In the case of an abandoned renewable energy project, funding may be immediately redirected to a new project. In one example, to reduce the inherent risks, the purchasing of green tags may be done close to the project's operating date.

Example pollution offsetting services include, but are not limited to, a financial service provider that provides a pollution offsetting benefit, environmental organizations that allow direct purchasing of pollution offset credits, and any combinations thereof. In one example, an offset provider may have a commitment to focusing funding on the construction of renewable energy projects rather than the subsidization of existing projects that would operate anyway. In one exemplary aspect, obtaining a pollution offset from such a provider may give a consumer added satisfaction of being associated with the creation of new renewable energy projects. In another aspect, such an investment may generate in the consumer satisfaction by contributing to a non-profit environmental organization, through the retirement of their green tags. In another example, a pollution offsetting service may be a financial institution that provides a consumer with a percentage of one or more transactions on an account (e.g., a credit account, a debit account, etc.) administered by the financial institution. That percentage may be utilized to participate in one or more pollution offsetting activities. Examples of utilizing a financial account are discussed further below.

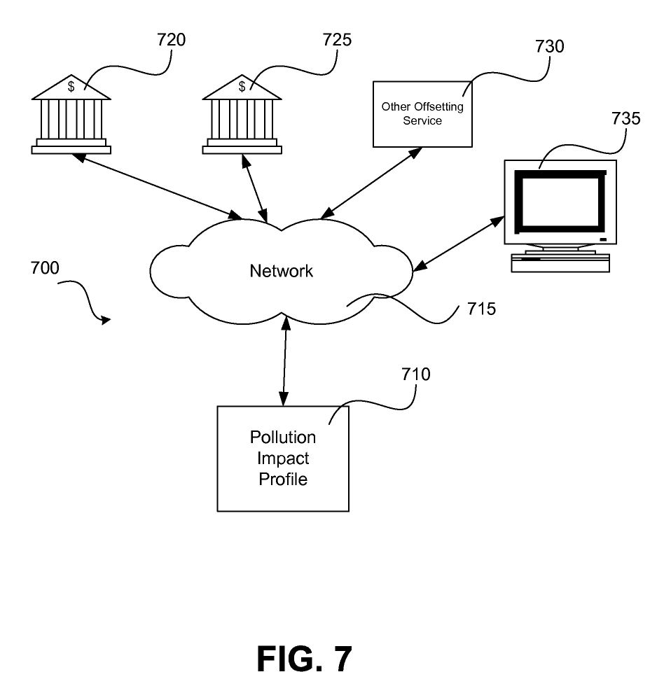

FIG. 7 illustrates one embodiment of a system 700 for associating one or more pollution offsetting services with a pollution impact profile. System 700 includes a pollution impact profile 710 connected with a network 715. Pollution impact profile 710 may include one or more of the aspects of a pollution impact profile discussed above. Example networks are set forth below with respect to FIG. 9. A first financial account 720 is associated with profile 710 via network 715. A second financial account 725 is also associated with profile 710 via network 715. In one example, data representing an amount of pollution offset may be transferred from a provider of a financial account (e.g., account 720 and/or 725). In another example, a financial account (e.g., account 720 and/or 725) may be administered by or in association with the provider of pollution impact profile 710. System 700 also illustrates an association with another offsetting service 730. Although each offsetting service 720, 725, and 730 is associated via the same network 715, it is contemplated that one or more additional networks may be utilized.

A consumer may also manually enter information related to pollution offset activity. Similar data entry options may be utilized to enter pollution offset activity as those that were discussed above with respect to data entry of pollution-related activity. System 700 includes a connection with a data entry device 735 (e.g., a computing device) for manually providing data related to pollution offset activity to pollution impact profile 710. For example, a consumer may purchase one or more pollution offsets from an organization that is not configured to directly transfer data to pollution impact profile 710 or the operator of the pollution impact profile. In such an example, profile 710 and any associated profiler (e.g., profiler 110 of FIG. 1) may be configured to receive manual entry of pollution offset data related to the purchased pollution offsets.

A consumer or a party on their behalf may access pollution impact profile 710 as discussed above to make an association with one or more pollution offsetting services and/or to manually enter data. In one example, a consumer may be provided a prompt (e.g., a displayable image, a text request) to provide information related to an offsetting service that they wish to associate with profile 710. In another example, an association may be initiated through a pollution offsetting service.

Data related to pollution offsets that are associated with a profile, such as profile 710, may be stored with or associated with the profile (e.g., in a database, such as database 125 of FIG. 1). In one example, data related to pollution offsets may be stored separately from data relating to a pollution footprint.

A pollution impact profile, such as profile 710, may utilize any data received from one or more associated pollution offsetting services to develop an indicator of an amount of a pollution (e.g., an amount of carbon emission) that has been offset by a consumer associated with the profile. In another example, an amount of pollution offset may be utilized to determine an effective pollution footprint. An effective pollution footprint is the pollution footprint for the consumer minus an amount of pollution offset by the consumer. For example, if the amount of carbon emission pollution attributable to a single consumer in the United States for a given year is about 40 tons (e.g., as determined from a pollution impact profile) and the consumer charges to an associated pollution offsetting credit card enough charges to purchase carbon emission offsets equivalent to about 25 tons of emissions, a current effective pollution footprint for that consumer for that year would be about 15 tons.

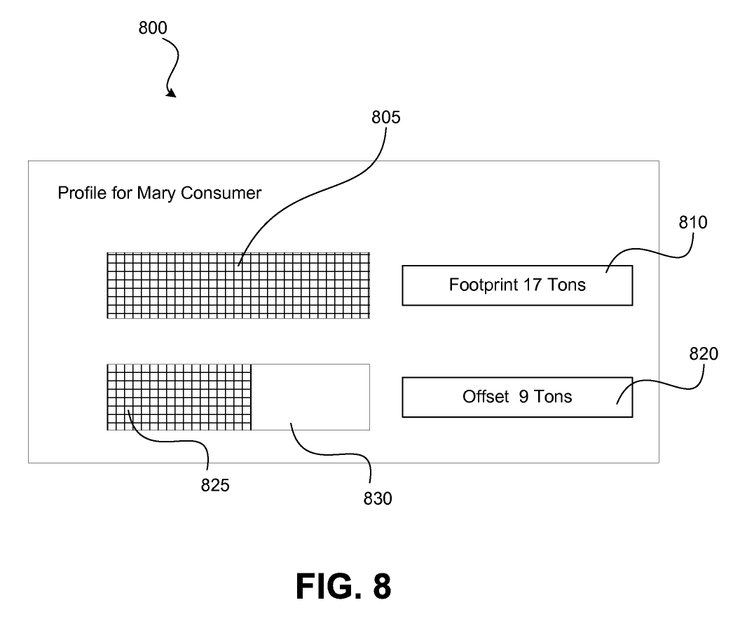

In another embodiment, a pollution impact profile may include pollution offset information (e.g., from a manually entered or directly transferred associated pollution offsetting service) in addition to pollution impact data. The pollution impact profile may utilize the combined information to generate an indication of a pollution footprint, an indication of an amount of pollution offset, an indication of an effective pollution footprint, or any combination thereof. A consumer may access one or more of these indications as discussed above with respect to providing of an indicator of a pollution footprint. FIG. 8 illustrates one example of a displayable image 800 of a exemplary pollution impact profile that includes an graphical indicator bar 805 that represents a consumer's pollution footprint. Displayable image 800 also includes a text indicator 810 that represents the consumer's pollution footprint. Displayable image 800 also includes a graphical indicator bar 815 and a text indicator 820 that represent an amount of pollution offset by the consumer. Graphical indicator bar 815 also gives a representation 825 of the consumer's effective pollution footprint, the amount of pollution not offset by the consumer.

In one exemplary aspect, a consumer may utilize a pollution impact profile to monitor progress toward a given pollution neutrality (e.g., if the pollution impact tracked by a profile is carbon emission, monitoring progress toward carbon neutrality). In one example, a consumer may be considered to be carbon neutral if he has a zero effective pollution footprint. In another example, a consumer may be carbon neutral when enough pollution offsets have been retired to reduce the consumer's effective pollution footprint to zero.

In yet another embodiment, an infrastructure and/or one or more tools may be provided in association with a pollution impact profile for networking a plurality of consumers that utilize a pollution impact profile. In one example, a pollution impact profile may include or have associated therewith a tool for use by the associated consumer that includes a prompt or other data entry device for associating one or more other consumers with their pollution impact profile. A consumer may choose to associate any other consumers. Exemplary associated consumers that may wish to associate themselves via their profiles may include, but are not limited to, school alumni, organizational members, current students, interest groups, municipalities, regional groups, and any combinations thereof. In another example, a tool may include a networking facility (e.g., a blog, a website, a newsletter, forum chatroom) for bringing consumers together that are working to reduce their pollution footprint. Such consumers may come together for many various reasons including, but not limited to, organizing environmental protests, conducting other political action, matchmaking, planning social events, and any combinations thereof. In one such example, a networking event of consumers that have each reached pollution neutrality would itself be carbon neutral. In yet another example, a tool may include functionality for sharing data related to a consumer's pollution footprint, pollution offsets, and/or effective pollution footprint with one or more other consumers. Combined data for a set of associated consumers may be utilized to provide an indicator of a combined pollution footprint, combined pollution offsets, and/or combined effective pollution footprint for the set of consumers.

As discussed above, an indicator of a pollution impact profile may be published in a variety of ways that may be accessible to the public. In yet another embodiment, a consumer (and/or the operator of a pollution impact profiler) may publicly publish a “status bar” (or other indicator). In one example, such a public publication may be to the consumer's own, or another's, website, blog, email signature, and/or online profiles (e.g. Friendster, Myspace, etc.). In another example, third parties (e.g., friends, family, associates, etc. of a consumer) may subscribe to a service to be updated of the consumer's effective pollution footprint and/or be updated to the progress of the consumer toward carbon neutrality. In still another example, a consumer may be provided with a digital carbon certificate that can be published to a third party. A digital carbon certificate may be a note awarding a day of carbon neutrality to an individual. In one aspect a digital carbon certificate may act to encourage a non-participant to become a participant and to work toward carbon neutrality themselves by utilizing a pollution impact profile as set forth herein.

In yet another embodiment, a provision (e.g., publication) of an indicator of a pollution impact profile may include an advertisement for a business affiliated with a provider of the pollution impact profile. An advertisement for a business may be associated with a payment of an advertisement charge for the advertisement. In one example, a percentage of an advertisement charge may be invested in one or more pollution offsetting activities on behalf of the corresponding business. In such an example, the business may participate in its own pollution impact profile. In one aspect, the corresponding amount of offset pollution by the business may be utilized by the business to indicate its environmental activity. Such an indication may provide value to the business in attracting environmentally conscious customers. In another example, a percentage of an advertisement charge may be invested in one or more environmentally clean energy projects, possibly on behalf of one or more consumers.

As discussed above, one example of a pollution offsetting service includes a credit account. Example credit accounts include, but are not limited to, a credit card account, a line of credit account, a debit card tied to a checking account, and any combinations thereof. It is contemplated that a credit account may include a plurality of credit accounts. Example credit card accounts include, but are not limited to, MasterCard, Visa, American Express, and Discover. In one example, a consumer may apply for a credit account directly with a banking institution that, in the case of a credit card account, may belong to one or more credit fulfillment networks (e.g., MasterCard, Visa, etc.). The banking institution may utilize methods recognized by those skilled in the art to approve the consumer for the credit account and activate the credit account (e.g., issue the consumer a credit card associated with the credit account). The consumer may then utilize the credit account for the purchase of goods and services anywhere that the credit account is honored. In such an example, the provider of the credit account may be affiliated with the provider of a pollution impact profile to the consumer. The consumer may choose to associate the credit account with their pollution impact profile as discussed above.

In this example, a percentage of one or more charges made to the credit account is determined. The percentage may be determined at about the time that a charge is posted to the credit account. In another example, the percentage may be determined at about the time payment is received from the consumer on the credit account for a charge. The percentage may be any percentage of one or more charges. In one example, the percentage is about one percent. In another example, the percentage is about 0.95%. The percentage is then utilized to participate in one or more pollution offsetting activities (e.g., purchasing pollution offsets and/or investing in an environmentally clean energy project. The participation in the one or more pollution offsetting activities may not present any additional charges to the consumer above the one or more charges initially incurred for the purchase of a good and/or a service.

In another example of a credit account associated with a pollution impact profile, a consumer may be issued a credit card. The credit card issuing institution may handle the issuance of the credit card. The consumer associates the credit card with their corresponding profile and/or the association is provided by the operator of the pollution impact profile. The consumer then shops for a good and/or a service at one or more merchants. The merchant's bank handles the processing of one or more charge transactions by the consumer utilizing the credit card. As payment for this service, the merchant's bank exacts both fixed (around $0.30) and percentage-based (around 2.5%) fees on the purchase. (The bank may also charge the merchant monthly and one-time fees.) The merchant's bank then settles the transaction with the card issuing bank, who charges the merchant's bank an interchange fee (around 1.5%) for this service. Finally, the card issuing bank bills the cardholder on a monthly basis for the charges incurred during that period.

In this example, 1% of purchase revenue may be provided (e.g., from the card issuing bank) for participating in a pollution offsetting activity. In this example, carbon offsets are purchased with the 1% and are retired on that cardholder's behalf. The consumer gets “credit” for this net reduction in global carbon pollution. This data is transferred to the consumer's pollution impact profile.

In yet another example of a credit account associated with a pollution impact profile, Julia has a Bright Card issued by Green Bank. Julia buys $100 worth of coffee beans at Good Coffee, an affiliated business. The merchant extends to Julia a 5% discount, so she pays $95 for the coffee. Good Coffee pays its merchant bank, Biz Bank, $0.30 and 2% per transaction (a total of $2.20), so it eventually receives $92.80 for the purchase. Since Good Coffee is an affiliated business, it reserves $1 (1% of the purchase) as part of a matching program and sends it to Business A, operator of the associated pollution impact profile. Its final revenue on this sale, therefore, is $91.80. Biz Bank settles this transaction with Green Bank, paying an interchange fee of $1.43. Green Bank collects $95 from Julia. Green Bank remits $0.95 to Business A as part of the rewards program. Business A keeps $0.005 for operating and other expenses. Business A purchases 0.945 tons of carbon offsets ($0.945 worth at a $10 per ton price of offset). These offsets are retired on Julia's behalf. Julia, who has a carbon emission footprint associated with her profile of 20 tons, is now almost 1% of the way towards carbon neutrality. Meanwhile, Good Coffee sends its $1 to Business A. Similarly, Business A keeps $0.005 (for a total of $0.01 for this transaction) and offsets 0.18 tons on behalf of Good Coffee (alternatively, the offset may be made on behalf of Julia).

In one exemplary aspect, a pollution impact profile may be configured to allow a more precise determination of an impact of a pollution attributable to a consumer. In another exemplary aspect, a pollution impact profile may be configured to allow a consumer to access an associated profile to modify and/or add additional actual data to their profile on an ongoing basis. In yet another exemplary aspect, a pollution impact profile may be configured to allow a consumer to associate pollution offsetting services with their profile. In still another exemplary aspect, a pollution impact profile may be configured to allow a notification to be sent to a consumer to prompt the user to return to their profile to add and/or modify data elements therein.

It is to be noted that the aspects and embodiments described herein may be conveniently implemented using one or more machines (e.g., a general purpose computing device) programmed according to the teachings of the present specification, as will be apparent to those of ordinary skill in the computer art. For example, various aspects of a method of developing an ongoing relationship with a consumer as described herein, may be implemented as machine-executable instructions (i.e., software coding), such as program modules executed by one or more machines. In one example, a pollution impact profiler, such as profiler 110 of FIG. 1, may include one or more programmed machines or one or more components of a programmed machine including any one or more machine-executable instruction for implementing aspects and embodiments (e.g., accessing, storing, modifying, etc. a pollution impact profile). In another example, a device used to access a pollution impact profile may include one or more programmed machines or one or more components of a programmed machine. Typically a program module may include routines, programs, objects, components, data structures, etc. that perform specific tasks. Appropriate machine-executable instructions can readily be prepared by skilled programmers based on the teachings of the present disclosure, as will be apparent to those of ordinary skill in the software art.

Such software may be a computer program product that employs a machine-readable medium. A machine-readable medium may be any medium that is capable of storing and/or encoding a sequence of instructions for execution by a machine (e.g., a computing device) and that causes the machine to perform any one of the methodologies and/or embodiments described herein. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory.

Examples of machine include, but are not limited to, a general purpose computer, a computer workstation, a terminal computer, a server computer, a handheld and/or mobile device (e.g., tablet computer, a personal digital assistant “PDA”, a mobile telephone, etc.), an information display device of an automobile, a web appliance, a network router, a network switch, a network bridge, any machine capable of executing a sequence of instructions that specify an action to be taken by that machine, and any combinations thereof. In one example, a machine may include and/or be included in, a kiosk.

FIG. 9 shows a diagrammatic representation of one embodiment of a machine in the exemplary form of a computer system 900 within which a set of instructions for causing the device to perform any one or more of the aspects and/or methodologies of the present disclosure may be executed. Computer system 900 includes a processor 905 and a memory 910 that communicate with each other, and with other components, via a bus 915. Bus 915 may include any of several types of bus structures including, but not limited to, a memory bus, a memory controller, a peripheral bus, a local bus, and any combinations thereof, using any of a variety of bus architectures.

Memory 910 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 920 (BIOS), including basic routines that help to transfer information between elements within computer system 900, such as during start-up, may be stored in memory 910. Memory 910 may also include (e.g., stored on one or more machine-readable media) instructions (e.g., software) 925 embodying any one or more of the aspects and/or methodologies of the present disclosure. In another example, memory 910 may further include any number of program modules including, but not limited to, an operating system, one or more application programs, other program modules, program data, and any combinations thereof.

Computer system 900 may also include a storage device 930. Examples of a storage device (e.g., storage device 930) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 930 may be connected to bus 915 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 930 may be removably interfaced with computer system 900 (e.g., via an external port connector (not shown)). Particularly, storage device 930 and an associated machine-readable medium 935 may provide nonvolatile and/or volatile storage of machine-readable instructions, data structures, program modules, and/or other data for computer system 900. In one example, software 925 may reside, completely or partially, within machine-readable medium 935. In another example, software 925 may reside, completely or partially, within processor 905.

Computer system 900 may also include an input device 940. In one example, a user of computer system 900 may enter commands and/or other information into computer system 900 via input device 940. Examples of an input device 940 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 940 may be interfaced to bus 915 via any of a variety of interfaces (not shown) including, but not limited to, a serial interface, a parallel interface, a game port, a USB interface, a FIREWIRE interface, a direct interface to bus 915, and any combinations thereof.

A user may also input commands and/or other information to computer system 900 via storage device 930 (e.g., a removable disk drive, a flash drive, etc.) and/or a network interface device 945. A network interface device, such as network interface device 945 may be utilized for connecting computer system 900 to one or more of a variety of networks, such as network 950, and one or more remote devices 955 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 950, may employ a wired and/or a wireless mode of communication. In general, any network topology may be used. Information (e.g., data, software 925, etc.) may be communicated to and/or from computer system 900 via network interface device 945.

Computer system 900 may further include a video display adapter 960 for communicating a displayable image to a display device, such as display device 965. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computer system 900 may include one or more other peripheral output devices including, but not limited to, an audio speaker, a printer, and any combinations thereof. Such peripheral output devices may be connected to bus 915 via a peripheral interface 970. Examples of a peripheral interface include, but are not limited to, a serial port, a USB connection, a FIREWIRE connection, a parallel connection, and any combinations thereof. In one example an audio device may provide audio related to data of computer system 900 (e.g., data representing an indicator related to pollution impact and/or pollution offset attributable to a consumer).

A digitizer (not shown) and an accompanying pen/stylus, if needed, may be included in order to digitally capture freehand input. A pen digitizer may be separately configured or coextensive with a display area of display device 965. Accordingly, a digitizer may be integrated with display device 965, or may exist as a separate device overlaying or otherwise appended to display device 965.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A machine-implemented method of developing an ongoing relationship with a consumer for assessing the pollution impact attributable to the consumer, the method comprising:
providing a first interactive session for use by the consumer;
providing a pollution impact profile representing a pollution impact attributable to the consumer wherein the pollution impact profile is based on a plurality of categories of pollution impact, each category of pollution impact including an impact arising from one or more pollution-related activities and having an initial value of impact;
allowing the consumer to provide a first data representing the consumer's actual pollution-related activities in at least one of the plurality of categories of pollution impact;
replacing at least a portion of the corresponding initial value of impact with the first data;
associating the pollution impact profile and the first data with the consumer such that the consumer may access the pollution impact profile during a second interactive session initiated after the termination of the first interactive session;
providing a first indicator of a pollution footprint based on the provided data and/or one or more of the initial values of impact;
allowing the consumer to associate one or more pollution offsetting services with the pollution impact profile for providing data related to pollution offset by the consumer; and
providing a second indicator based on an amount of pollution offset by the consumer.

2. A machine-implemented method according to claim 1, wherein the plurality of categories includes one or more categories each allocated to a specific category of pollution impact and an unallocated category representing a portion of the pollution impact attributable to the consumer that is not allocated to a specific category of pollution impact.

3. A machine-implemented method according to claim 2, further comprising improving the accuracy of the pollution impact profile by allocating at least a portion of the unallocated category to a new or existing specific category of pollution impact.

4. A machine-implemented method according to claim 1, wherein the pollution impact attributable to the consumer includes carbon emissions.

5. A machine-implemented method according to claim 1, further comprising:
providing the second interactive session for use by the consumer;
allowing the consumer to provide additional data representing the consumer's actual pollution related activities in at least one of the plurality of categories of pollution impact for replacing at least a portion of a previously provided data and/or a portion of an initial value of impact; and
providing an updated indicator of the pollution footprint.

6. A machine-implemented method according to claim 1, wherein the consumer provides data by a process that includes a procedure selected from the group consisting of a web page, an SMS feed, a text message, a web services dialogue using an application programming interface (API), a formatted email message, an instant message, an electronic chat message, a widget message, wireless data communication, a data communication from a device installed in an automobile or other vehicle that communicates data related to vehicle operation, a data communication from a device installed in a home that communicates data related to pollution-generating home use, a data communication from a travel operator, a data communication from a touch-tone telephone, a data communication from a utility provider, and any combinations thereof.

7. A machine-implemented method according to claim 1, wherein at least one of said providing of an indicator steps includes publishing an indicator to a location selected from the group consisting of a web page, an email, an electronic signature, a mobile device display, a financial account statement, a personal away message, a publicly accessible advertisement, XML-based syndication, SMS, a postal mailing, an instant messaging, an audio feed, an audio phone call and/or message, a publication to an automobile dashboard, other electronic and non-electronic publication media, a credit account statement, and any combinations thereof.

8. A machine-implemented method according to claim 1, wherein the one or more pollution offsetting services includes a financial account of the consumer and the method further comprises:
allocating a percentage of one or more transactions associated with the financial account in a pollution offsetting activity; and
reducing a portion of the pollution footprint of the consumer by an amount of pollution offset by said investing.

9. A machine-implemented method according to claim 1, wherein the providing of the first indicator includes iteratively updating the value of the first indicator as the consumer provides each actual data.

10. A machine-implemented method according to claim 1, further comprising:
pooling data related to a plurality of pollution footprints for a plurality of affiliated consumers; and
providing a third indicator of a total pollution footprint for the plurality of affiliated consumers.

11. A machine-implemented method according to claim 1, further comprising:
pooling data related to a plurality of pollution footprints for a plurality of affiliated consumers; and
providing a third indicator based on total amount of pollution offset by the affiliated consumers.

12. A system for developing an ongoing relationship with a consumer for assessing the pollution impact attributable to the consumer, the system comprising:
a means for providing a first interactive session for use by the consumer;
a means for providing a pollution impact profile representing a pollution impact attributable to the consumer wherein the pollution impact profile is based on a plurality of categories of pollution impact, each category of pollution impact including an impact arising from one or more pollution-related activities and having an initial value of impact;
a means for allowing the consumer to provide a first data representing the consumer's actual pollution-related activities in at least one of the plurality of categories of pollution impact;
a means for replacing at least a portion of the corresponding initial value of impact with the first data;
a means for associating the pollution impact profile and the first data with the consumer such that the consumer may access the pollution impact profile during a second interactive session initiated after the termination of the first interactive session;
a means for providing a first indicator of a pollution footprint based on the provided data and/or one or more of the initial values of impact;
a means for allowing the consumer to associate one or more pollution offsetting services with the pollution impact profile for providing data related to pollution offset by the consumer; and
a means for providing a second indicator of the progress of the consumer toward offsetting the pollution footprint.

13. A machine-readable medium containing computer executable instructions implementing a method of developing an ongoing relationship with a consumer for assessing the pollution impact attributable to the consumer, the instructions comprising:
a set of instructions for providing a first interactive session for use by the consumer;
a set of instructions for providing a pollution impact profile representing a pollution impact attributable to the consumer wherein the pollution impact profile is based on a plurality of categories of pollution impact, each category of pollution impact including an impact arising from one or more pollution-related activities and having an initial value of impact;
a set of instructions for allowing the consumer to provide a first data representing the consumer's actual pollution-related activities in at least one of the plurality of categories of pollution impact;
a set of instructions for replacing at least a portion of the corresponding initial value of impact with the first data;
a set of instructions for associating the pollution impact profile and the first data with the consumer such that the consumer may access the pollution impact profile during a second interactive session initiated after the termination of the first interactive session;
a set of instructions for providing a first indicator of a pollution footprint based on the provided data and/or one or more of the initial values of impact;
a set of instructions for allowing the consumer to associate one or more pollution offsetting services with the pollution impact profile for providing data related to pollution offset by the consumer; and
a set of instructions for providing a second indicator of the progress of the consumer toward offsetting the pollution footprint.

14. A machine-readable medium according to claim 13, wherein the plurality of categories includes one or more categories each allocated to a specific category of impact and an unallocated category representing a portion of the pollution impact attributable to the consumer that is not allocated to a specific category of pollution impact.

15. A machine-readable medium according to claim 14, further comprising a set of instructions for allocating at least a portion of the unallocated category to a new or existing specific category of pollution impact.

16. A machine-readable medium according to claim 13, wherein the one or more pollution offsetting services includes a financial account of the consumer and the instructions further comprise:
a set of instructions for allocating a percentage of one or more transactions associated with the financial account in a pollution offsetting activity; and
a set of instructions for reducing a portion of the pollution footprint of the consumer by an amount of pollution offset by said investing.

17. A machine-readable medium according to claim 13, further comprising:
a set of instructions for pooling data related to a plurality of pollution footprints for a plurality of affiliated consumers; and
a set of instructions for providing a third indicator of a total pollution footprint for the plurality of affiliated consumers.

18. A machine-implemented method according to claim 13, wherein the set of instructions for publishing of the first indicator includes a set of instructions for iteratively updating the value of the first indicator as the consumer provides each actual data.

19. A machine-implemented method of developing an ongoing relationship with a consumer for assessing the pollution impact attributable to the consumer, the method comprising:
providing a first interactive session for use by the consumer;
providing a pollution impact profile representing a pollution impact attributable to the consumer wherein the pollution impact profile is based on a plurality of categories of pollution impact including one or more allocated categories each representing a specific type of impact arising from a related one or more activities and an unallocated category representing a portion of the pollution impact attributable to the consumer that is not allocated to a specific type of impact, wherein each of the plurality of categories has an initial value of impact;
allowing the consumer to provide a first data representing the consumer's actual pollution-related activities in at least one of the plurality of categories of impact for replacing at least a portion of the corresponding initial value of impact;
associating the pollution impact profile and the first data with the consumer such that the consumer may access the pollution impact profile during a second interactive session initiated after the termination of the first interactive session;
providing a first indicator of a pollution footprint based on the provided data and/or one or more of the initial values of impact; and
updating the pollution impact profile by allocating at least a portion of the unallocated category to a new or existing allocated category of pollution impact; and
providing a second indicator of the pollution footprint utilizing a value based on the updated pollution impact profile.

20. A method according to claim 19, further comprising:
allowing the consumer to associate one or more pollution offsetting services with the pollution impact profile for providing data related to pollution offset by the consumer; and
providing a third indicator of the progress of the consumer toward offsetting the pollution footprint.

21. A machine-implemented method according to claim 19, further comprising:
providing the second interactive session for use by the consumer;
allowing the consumer to provide additional data representing the consumer's actual pollution related activities in at least one of the plurality of categories of impact for replacing at least a portion of a previously provided data and/or a portion of an initial value of impact; and
providing an updated indicator of the pollution footprint.

22. A pollution impact system for developing an ongoing relationship with a consumer that relates to a pollution impact attributable to the consumer, the system comprising:
a database accessible via a network; and
a pollution impact profile in said database, the pollution impact profile including:
a plurality of allocated categories of pollution impact, each of said plurality of categories based on one or more data elements associated with a corresponding one or more activities related to a pollution impact, each of said plurality of allocated categories representing a first portion of the pollution impact attributable to the consumer and having an initial value of impact in said database, wherein each of said plurality of categories is configured to be accessed and modified by the consumer with one or more actual pollution impact data values that relate to at least one of said one or more data elements; and
an unallocated category of pollution impact representing a second portion of the pollution impact attributable to the consumer that is not allocated to one of said plurality of allocated categories, wherein said second portion is configured to be modified to be allocated to a new allocated category upon acquisition of knew knowledge related to one or more activities that contribute to the pollution impact attributable to the consumer.
